(19) United States
(12) Patent Application Publication
(10) Pub. No.: US 2009/0269559 A1
(43) Pub. Date: Oct. 29, 2009

(54) PRINTED CIRCUIT BOARD AND MANUFACTURING METHOD THEREOF

(75) Inventors: Ro-Woon LEE, Seoul (KR); Jae-Woo JOUNG, Suwon-si (KR); Kyoung-Jin JEONG, Seoul (KR); Tae-Gu KIM, Hwaseong-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/355,288

(22) Filed: Jan. 16, 2009

(30) Foreign Application Priority Data
Apr. 29, 2008 (KR) 10-2008-0039722

(51) Int. Cl. B32B 27/34; B29C 65/02

(52) U.S. Cl. 428/201; 156/277

(57) ABSTRACT

A printed circuit board and a method of manufacturing the printed circuit board are disclosed. The method of manufacturing the printed circuit board can include adhering a film to an insulation base, in which the film is configured to flatten a surface of the insulation base, thermosetting the film, and forming a circuit pattern on the film by way of ink-jetting. In accordance with the present invention, a surface of the insulation base can be flattened and the surface roughness thereof can be made uniform, so that the diffusivity of the circuit pattern can be controlled while printing a minute circuit pattern and an adhesive strength between the insulation base and the circuit pattern can be increased.

### CROSS-REFERENCE TO RELATED APPLICATIONS

This application claims the benefit of Korean Patent Application No. 10-2008-0039722 filed with the Korean Intellectual Property Office on Apr. 29, 2008, the disclosure of which is incorporated herein by reference in its entirety.

### BACKGROUND

1. Technical Field

The present invention relates to a printed circuit board and a method of manufacturing the printed circuit board.

2. Description of the Related Art

In recent years, the flat display industry has rapidly grown. For that reason, the growth of liquid crystal display (LCD), plasma display panel (PDP), etc. seems to overtake the market size of the semiconductor industry, and organic light emitting diodes, field emission display (FED), etc. are also expected to be next-generation displays.

Korea has been on favorable ground as a manufacturing base for the world's flat display industry due to Korea's strength in manufacturing technology and massive investment, and now Korea has been leading the way in development fields for a new technology and a new product.

However, it is true that there is still a gap between Korea and advanced nations in terms of manufacturing equipments, core components and fundamental technologies in spite of a physical economic growth. In particular, the field of an initial process among equipment technologies are mostly depending on imports from abroad in spite of efforts by many domestic equipment manufacturers.

The focus of attention among equipment technologies is an ink-jet printing technology, in which a desired pattern can be made without a process of photo-lithography that is conventional and complicated. The ink-jet printing technology is particularly expected as the most competitive production technology in the field of organic light emitting diodes and has a wide range of applications in LCD, PDP, FED, etc.

Currently, an ink-jet method is used at various fields of industry. However, the method is mainly used in display field, where production costs may be saved in the future. The time required to produce can be saved by precisely printing at a desired area where the production technology is applied to a color filter and to form an electrode.

FIG. 1 is a cross-sectional view illustrating a method of manufacturing a printed circuit board in accordance with the related art. As illustrated in the drawing, an insulation base 1 can have a rough surface since it is made of a glass-fiber and resin, and thus the direct printing of a fine circuit pattern 2 on the rough surface of the insulation base 1 can be difficult to achieve by way of ink-jetting.

When ink-jet printing, there is also a problem of the adhesive strength between a circuit pattern 2 and the insulation base 1, which is mainly caused by a problem of the adhesive strength between an inkblot and a parent metal. That is, the conventional method described above can be limited in use to form a minute pattern against such demands of a highly efficient product by way of minute patterning of an electrode.

### SUMMARY

An aspect of the invention provides a printed circuit board and a method of manufacturing the printed circuit board, in which a surface of an insulation base can be flattened and the surface roughness thereof can be made uniform, so that the diffusivity of a circuit pattern can be controlled while printing a minute circuit pattern and an adhesive strength between an insulation base and the circuit pattern can be increased.

Another aspect of the invention provides a method of manufacturing a printed circuit board. The method can include adhering a film to an insulation base, in which the film is configured to flatten a surface of the insulation base, thermosetting the film, and forming a circuit pattern on the film by way of ink-jetting.

The film can be made of a polyimide or a compound comprising a silane.

Also, the silane can be made of a material including at least one selected from a group consisting of monosilane (SiH₄), disilane (Si₂H₆), torisilane (Si₃H₈) and tetrasilane (Si₄H₁₀).

In addition, the film can be fabricated to include 5˜30 parts by weight of the silane compound per 100 parts by weight of the polyimide, and the thickness of the film can be formed less than 5 μm.

Still another aspect of the invention provides a printed circuit board. The printed circuit board can include an insulation base, a film adhered to the insulation base, in which the film is configured to flatten a surface of the insulation base, and a circuit pattern formed on the film by way of ink-jetting.

The film can be made of a polyimide or a compound comprising a silane.

Also, the silane can be made of a material including at least one selected from a group consisting of monosilane (SiH₄), disilane (Si₂H₆), torisilane (Si₃H₈), and tetrasilane (Si₄H₁₀).

In addition, the film can be fabricated to include 5˜30 parts by weight of the silane compound per 100 parts by weight of the polyimide, and the thickness of the film can be formed less than 5 μm.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view illustrating a method of manufacturing a printed circuit board in accordance with the related art.

FIG. 2 is a flowchart illustrating a method of manufacturing a printed circuit board in accordance with the present invention.

FIGS. 3 to 6 are flow diagrams illustrating a method of manufacturing a printed circuit board in accordance with the present invention.

FIG. 7 is a cross-sectional view illustrating a printed circuit board in accordance with the present invention.

FIG. 8 is a photograph illustrating a liquid-drop shape printed on a insulation base being surface-treated in accordance with the present invention.

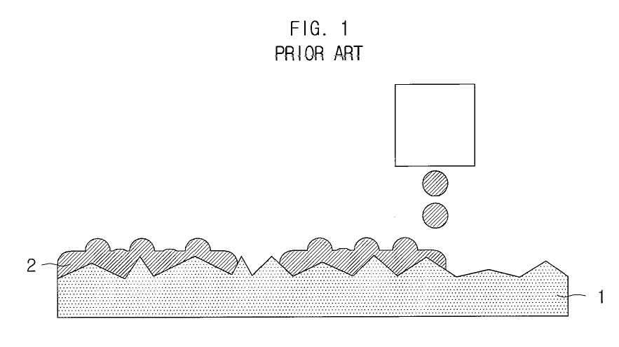

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

A printed circuit board and a method of manufacturing the printed circuit board in accordance with certain embodiments of the present invention will be described below in more detail with reference to the accompanying drawings. Those components that are the same or are in correspondence are rendered the same reference numeral regardless of the figure number, and redundant explanations are omitted.

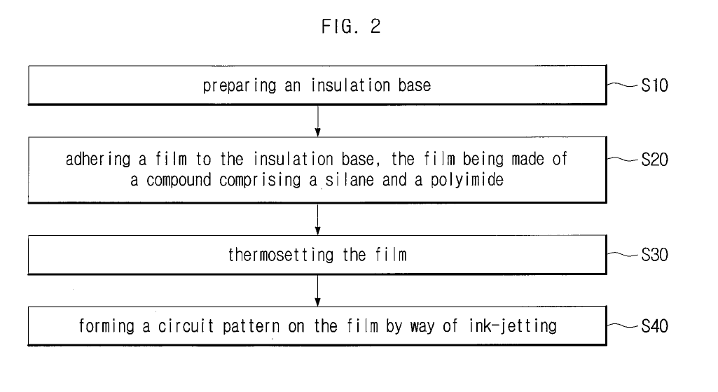

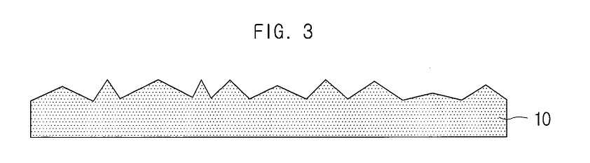

FIG. 2 is a flowchart illustrating a method of manufacturing a printed circuit board in accordance with the present invention, and FIGS. 3 to 6 are flow diagrams illustrating a method of manufacturing a printed circuit board in accordance with the present invention.

Illustrated in FIGS. 3 to 6 are an insulation base 10, a film 20, a circuit pattern 30 and an ink-jet head 40.

In the present embodiment, a film can be adhered to an insulation base, in which the film is configured to flatten a surface of the insulation base, and the film can be thermo-hardened, and a circuit pattern can be formed on the film by way of ink-jetting. Therefore, a surface of the insulation base can be flattened and the surface roughness thereof can be made uniform, so that the diffusivity of the circuit pattern can be controlled while printing a minute circuit pattern and an adhesive strength between the insulation base and the circuit pattern can be increased.

Firstly, prepared the insulation base 10 as illustrated in FIG. 3 (S10). The insulation base 10 has a rough surface since the base is made of a glass-fiber and resin. For that reason, the direct printing of a minute circuit on the rough surface of the insulation base 10 can be difficult to achieve by way of ink-jetting.

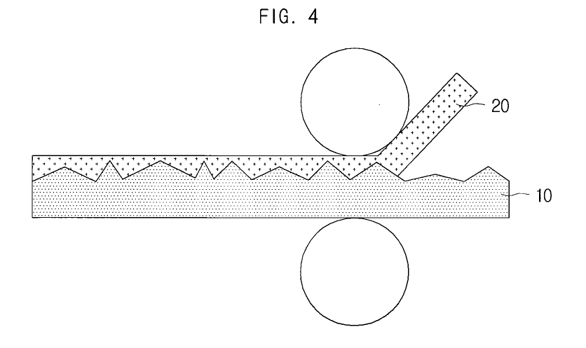

Consequently, for achieving the fine circuit patterning, the insulation base 10 can be adhered to a film 20 as illustrated in FIG. 4 (S20). Here, the film 20 can be made of a polyimide or a compound comprising a silane. Also, the film 20 can be fabricated to include 5˜30 parts by weight of the silane compound per 100 parts by weight of the polyimide.

In addition, the silane can be made of a material including at least one selected from a group consisting of monosilane (SiH₄), disilane (Si₂H₆), torisilane (Si₃H₈) and tetrasilane (Si₄H₁₀), and the thickness of the film can be formed less than 5 μm. If the thickness of the film is over 5 μm, the board can become curved due to an internal stress.

The silane being a hydrophobic substance can be added to the polyimide to produce the film 20, and thus the diffusivity of a circuit pattern 30 formed on the film can be minimized.

Furthermore, by adhering the film 20 being made of the polyimide and the silane to the rough surface of the insulation base 10, the surface of the insulation base can become flat, and the diffusivity of the circuit pattern 30 being formed on the film can be controlled. Thus, the printing of fine circuit patterning can be done more easily.

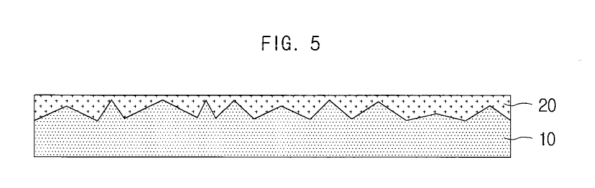

Next, as illustrated in FIG. 5, the film 20 is treated by way of thermosetting (S30). By thermosetting the film 20 adhered to the insulation base 10, the surface roughness of the film 20 can be more uniform, and the surface of the film 20 can be also flat. For that reason, the fine circuiting patterning of the circuit pattern 30 can be done.

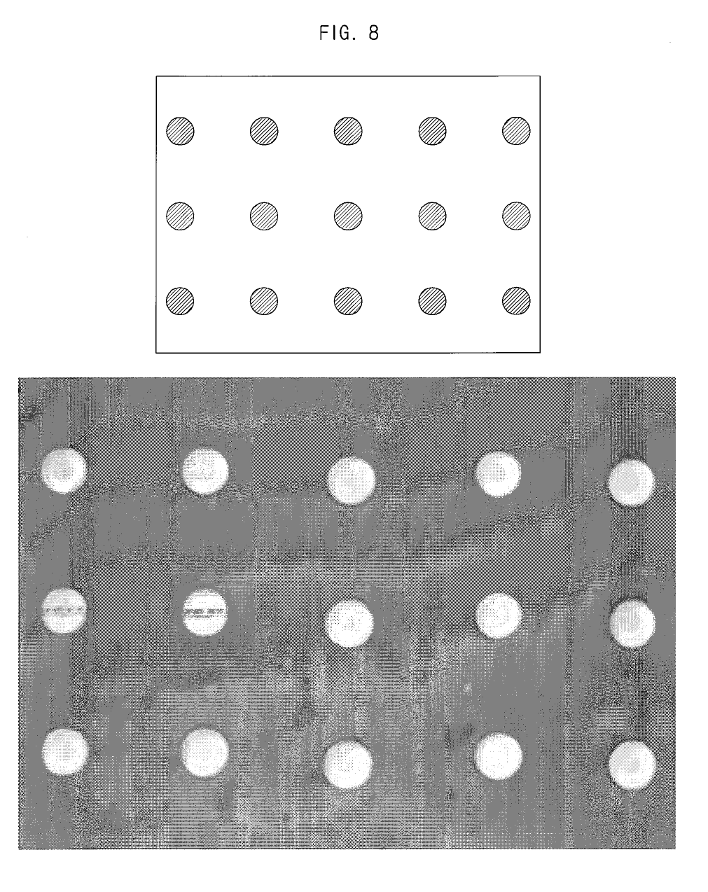

FIG. 8 is a photograph illustrating a liquid-drop shape printed on a insulation base being surface-treated in accordance with the present invention. As illustrated in FIG. 8, a liquid-drop printed on the film 20 directly by way of ink-jetting can have an impact liquid-drop shape after thermosetting the film 20 being made of a compound comprising the silane and the polyimide, in which the film 20 is adhered to the insulation base 10. The fine circuit patterning of the circuit pattern 30 being in an impact liquid-drop shape and being formed by way of ink-jet printing can be formed on the film 20 without a tendency to diffusion.

In other words, if the film 20 being made of a compound comprising the silane and the polyimide is adhered to the insulation base 10 and thermo-hardened, the surface roughness of the insulation base 10 can be uniform, and the surface thereof can become flat. Therefore, when the circuit pattern 30 is printed on the film 20 by way of ink-jet patterning, the circuit pattern can be formed in an impact liquid-drop shape and thus the fine circuit patterning can be done.

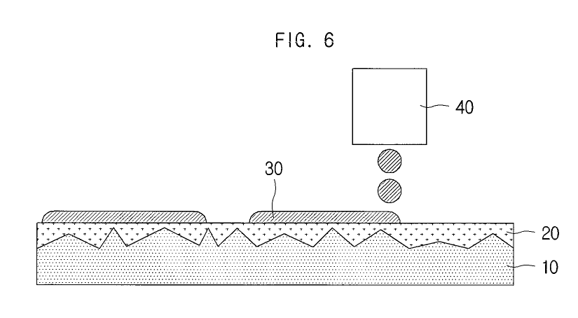

Next, as illustrated in FIG. 6, the circuit pattern 30 can be formed on the film 20 by way of ink-jetting (S40). Here, the circuit pattern 30 can be formed on the film 20 by forming an ink blot from an ink-jet head 40.

As set forth above, if printing the circuit pattern 30 after stacking the film 20, being made of a compound comprising the silane and the polyimide, on the rough surface of the insulation base 10, an ink-drop on the film 20 can be formed in an impact liquid-drop shape and thus the fine circuit patterning can be done.

After forming the circuit pattern 30, the adhesive strength between the film 20 of the insulation base 10 and the circuit pattern 30 can be effectively increased through a process of sintering. Therefore, the problem of the adhesive strength between a conventional board and a circuit pattern can be solved.

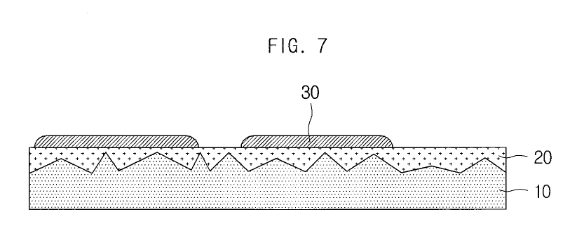

FIG. 7 is a cross-sectional view illustrating a printed circuit board in accordance with the present invention. Illustrated in FIG. 7 are an insulation base 10, a film 20 and a circuit pattern 30.

As set forth above, by adhering the film 20 being made of a compound comprising the silane and the polyimide on the rough surface of the insulation base 10, the surface roughness of the insulation base 10 can be uniform, and the surface thereof can become flat. Therefore, the diffusivity of the circuit pattern 30 can be controlled and thus the fine circuit patterning can be done.

Here, the film 20 can be made of a polyimide or a compound comprising a silane and fabricated to include 5˜30 parts by weight of the silane compound per 100 parts by weight of the polyimide.

In addition, the silane can be made of a material including at least one selected from a group consisting of monosilane (SiH₄), disilane (Si₂H₆), torisilane (Si₃H₈) and tetrasilane (Si₄H₁₀), and the thickness of the film can be formed less than 5 μm. If the thickness of the film is over 5 μm, the board can become curved due to an internal stress.

As set forth above, the present invention provides a printed circuit board and a method of manufacturing the printed circuit board, in which a surface of an insulation base can be flattened and the surface roughness thereof can be made uniform, so that diffusion of a circuit pattern can be controlled while printing a minute circuit pattern and an adhesive strength between an insulation base and the circuit pattern can be increased.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. As such, many embodiments other than those set forth above can be found in the appended claims.

What is claimed is:

1. A method of manufacturing a printed circuit board, the method comprising:
adhering a film to an insulation base, the film configured to flatten a surface of the insulation base;
thermosetting the film; and
forming a circuit pattern on the film by way of ink-jetting.

2. The method of claim 1, wherein the film is made of a polyimide.

3. The method of claim 2, wherein the film is made of a compound comprising a silane.

4. The method of claim 3, wherein the silane is made of a material including at least one selected from a group consisting of monosilane (SiH₄), disilane (Si₂H₆), torisilane (Si₃H₈) and tetrasilane (Si₄H₁₀).

5. The method of claim 4, wherein the film is fabricated to include 5˜30 parts by weight of the silane compound, per 100 parts by weight of the polyimide.

6. The method of claim 1, wherein the thickness of the film is formed less than 5 μm.

7. A printed circuit board comprising:
an insulation base;
a film adhered to the insulation base, the film configured to flatten a surface of the insulation base; and
a circuit pattern formed on the film by way of ink-jetting.

8. The printed circuit board of claim 7, wherein the film is made of a polyimide.

9. The printed circuit board of claim 8, wherein the film is made of a compound comprising a silane.

10. The printed circuit board of claim 9, wherein the silane is made of a material including at least one selected from a group consisting of monosilane (SiH₄), disilane (Si₂H₆), torisilane (Si₃H₈), and tetrasilane (Si₄H₁₀).

11. The printed circuit board of claim 10, wherein the film is fabricated to include 5˜30 parts by weight of the silane compound, per 100 parts by weight of the polyimide.

12. The printed circuit board of claim 7, wherein the thickness of the film is formed less than 5 μm.
